(19) United States
(12) Patent Application Publication
(10) Pub. No.: US 2008/0215343 A1
(43) Pub. Date: Sep. 4, 2008

(54) AUDIO DECODING APPARATUS AND AUDIO DECODING SYSTEM

(76) Inventors: Hiroyuki Goto, Osaka (JP); Masahiro Sueyoshi, Osaka (JP)

Correspondence Address: MCDERMOTT WILL & EMERY LLP, 600 13TH STREET, NW, WASHINGTON, DC, 20005-3096, US

(21) Appl. No.: 12/040,664

(22) Filed: Feb. 29, 2008

(30) Foreign Application Priority Data
Mar. 1, 2007 (JP) 2007-051676

(51) Int. Cl. G10L 19/00

(52) U.S. Cl. 704/500; 704/E19.001

(57) ABSTRACT

A work memory for storing a compressed audio stream to be decoded, a plurality of decoding process sections, and a plurality of output process sections are provided. A control section switches the start and stop of a decoding process between each decoding process section in predetermined switching cycles so that only any one of the decoding process sections uses the work memory to perform a decoding process at any single point of time, and saves, into an outside of an audio decoding apparatus, a compressed audio stream stored in the work memory which has been referenced by a decoding process section to be caused to stop a decoding process. When a stopped decoding process section is caused to resume a decoding process, the control section reads a compressed audio stream saved for the decoding process section to be caused to resume the decoding process, from the outside.

### BACKGROUND OF THE INVENTION

1. Field of the Invention

The present invention relates to an audio decoding apparatus for simultaneously decoding a plurality of compressed audio streams and outputting the results as audio signals.

2. Description of the Related Art

In recent years, various decoder LSIs (Large Scale Integrated circuits) which decode compressed video and audio streams have been developed along with advances in the communications technology and the diversity of video/audio apparatuses. Of the decoder LSIs, there is a known decoder LSI which reads data into an internal work memory and decodes the data using the work memory (see, for example, Japanese Unexamined Patent Application Publication H08-279759). With the decoder LSI comprising the work memory, video and audio streams can be decoded without providing an external high-speed memory.

There is also a known high-performance system LSI which simultaneously decodes two channels of high-definition video streams (see, for example, Matsushita Electric Industrial, Co. Ltd., “Home AV UniPhier (registered trademark) System LSI Has Been Developed”, retrieved on Dec. 15, 2006 from the Internet at URL: http://panasonic.co.jp/corp/news/official.data/data.dir/jn060301-1/jn060301-1.html).

For example, in the conventional decoder LSI which employs the internal work memory for decoding and in which a plurality of compressed audio streams are simultaneously decoded and the results are output as audio signals, the size of the work memory in the chip may be set so that the compressed audio streams can be simultaneously stored.

However, if the size of the internal work memory is set, depending on the number of streams which are simultaneously decoded (decoding process), the cost increases.

### SUMMARY OF THE INVENTION

In view of the above-described problems, the present invention has been achieved. An object of the present invention is to reduce the size of a work memory which is required to simultaneously decode a plurality of compressed audio streams.

According to an aspect of the present invention, an audio decoding apparatus is provided for decoding n (n: a natural number of 2 or more) input compressed audio streams to output n audio signals. The audio decoding apparatus comprises a work memory for storing compressed audio streams to be decoded, read from input buffers provided outside the audio decoding apparatus, corresponding to the respective compressed audio streams, n decoding process sections provided, corresponding to the respective compressed audio streams, for decoding the respective corresponding compressed audio streams to output respective pieces of audio data, n output process sections provided, corresponding to the respective decoding process sections, for converting the respective pieces of audio data output by the respective corresponding decoding process sections into respective audio signals and outputting the respective audio signals, and a control section for controlling reading of the compressed audio streams to be decoded into the work memory, and the start and stop of a decoding process in each decoding process section. The decoding process sections decode the respective corresponding compressed audio streams read into the work memory, and output the respective pieces of audio data to respective corresponding output buffers provided outside the audio decoding apparatus, corresponding to the respective decoding process sections. The output process sections read out the respective pieces of audio data from the respective corresponding output buffers and convert the respective pieces of audio data into the respective audio signals. The control section switches the start and stop of a decoding process between each decoding process section in predetermined switching cycles so that only any one of the decoding process sections uses the work memory to perform a decoding process at any single point of time. During the switching, the control section saves, into a save buffer, a compressed audio stream stored in the work memory which has been referenced by a decoding process section to be caused to stop a decoding process, save buffers being provided outside the audio decoding apparatus, corresponding to the respective corresponding decoding process sections. When a stopped decoding process section is caused to resume a decoding process, the control section reads a compressed audio stream saved for the decoding process section to be caused to resume the decoding process, from the corresponding save buffer into the work memory.

According to another aspect of the present invention, an audio decoding apparatus is provided for decoding n (n: a natural number of 3 or more) input compressed audio streams to output n audio signals. The audio decoding apparatus comprises a work memory for storing compressed audio streams to be decoded, read from input buffers provided outside the audio decoding apparatus, corresponding to the respective compressed audio streams, n decoding process sections provided, corresponding to the respective compressed audio streams, for decoding the respective corresponding compressed audio streams to output respective pieces of audio data, n output process sections provided, corresponding to the respective decoding process sections, for converting the respective pieces of audio data output by the respective corresponding decoding process sections into respective audio signals and outputting the respective audio signals, and a control section for controlling reading of the compressed audio streams to be decoded into the work memory, and the start and stop of a decoding process in each decoding process section. The decoding process sections decode the respective corresponding compressed audio streams read into the work memory, and output the respective pieces of audio data to respective corresponding output buffers provided outside the audio decoding apparatus. The output process sections read out the respective pieces of audio data from the respective corresponding output buffers and convert the respective pieces of audio data into the respective audio signals. The control section switches the start and stop of a decoding process between each decoding process section in predetermined switching cycles so that only any one of the decoding process sections uses the work memory to perform a decoding process at any single point of time. The control section saves, into a save buffer, a compressed audio stream stored in the work memory which has been referenced by a stopped decoding process section, save buffers being provided outside the audio decoding apparatus, corresponding to the respective corresponding decoding process sections, while a decoding process section which uses the work memory next to the stopped decoding process section is performing a decoding process, and thereafter, the control section reads, into the work memory, a compressed audio stream which is referenced by a decoding process section which will use the work memory next to the decoding process section currently performing the decoding process.

### BRIEF DESCRIPTION OF THE DRAWINGS

FIG. 1 is a block diagram showing a configuration of an audio decoding system 100 according to Embodiment 1 of the present invention.

FIG. 2 is a diagram showing a process sequence of each part of the audio decoding system 100.

FIG. 3 is a flowchart showing an underflow process in a control section 112.

FIG. 4 is a flowchart showing an overflow process in a control section 112.

FIG. 5 is a diagram showing a process sequence when a skipping process is performed with respect to outputting of an audio signal in an audio decoding apparatus 120.

FIG. 6 is a diagram showing a process sequence of stopping outputting the audio decoding apparatus 120 and canceling a stop.

FIG. 7 is a diagram for describing a decoding process sequence of switching of two compressed audio streams, depending on the remaining amounts of data of a first output buffer 108 and a second output buffer 109 in the control section 112.

FIG. 8 is a functional block diagram showing a configuration of an audio decoding system 200 according to Embodiment 2 of the present invention.

FIG. 9 is a diagram showing a process sequence of each part of the audio decoding system 200.

### DETAILED DESCRIPTION OF THE PREFERRED EMBODIMENTS

Hereinafter, embodiments of the present invention will be described with reference to the accompanying drawings. Note that like parts are indicated by like reference numerals throughout the specification and will not be repeatedly described.

### Embodiment 1

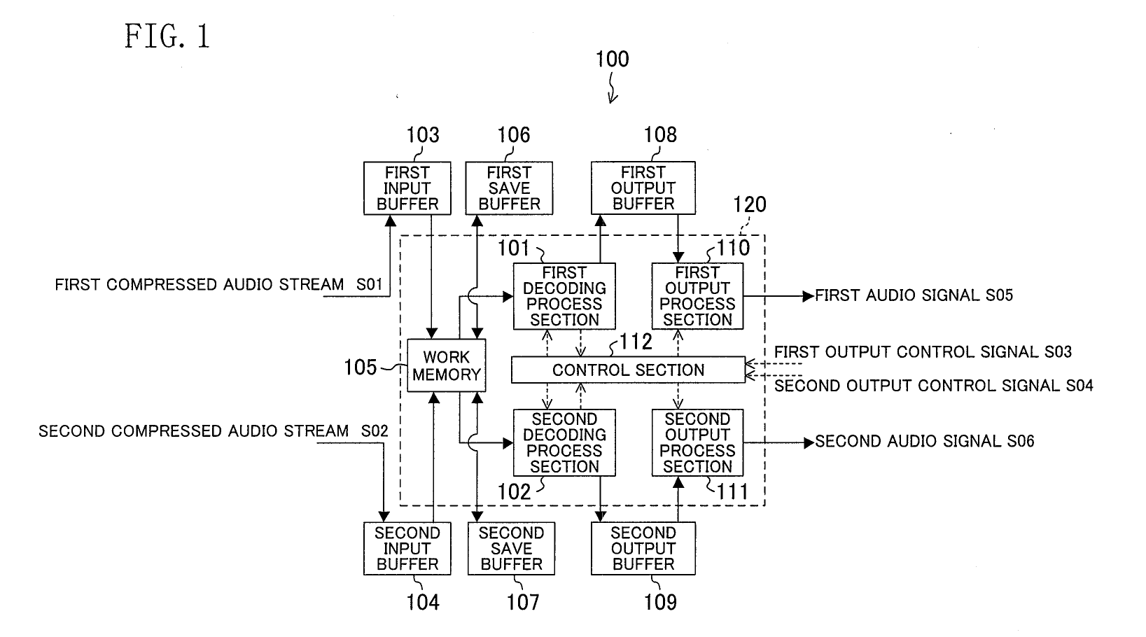

FIG. 1 is a block diagram showing a configuration of an audio decoding system 100 according to Embodiment 1 of the present invention. The audio decoding system 100 decodes (decoding process) and reproduces two compressed audio streams (a first compressed audio stream S01 and a second compressed audio stream S02).

(Configuration of Audio Decoding System 100)

As shown in FIG. 1, the audio decoding system 100 comprises a first decoding process section 101, a second decoding process section 102, a first input buffer 103, a second input buffer 104, a work memory 105, a first save buffer 106, a second save buffer 107, a first output buffer 108, a second output buffer 109, a first output process section 110, a second output process section 111, and a control section 112.

The first decoding process section 101 and the second decoding process section 102 decode the first compressed audio stream S01 and the second compressed audio stream S02, respectively, in accordance with a control (described below) by the control section 112.

The first input buffer 103 holds the input first compressed audio stream S01. The second input buffer 104 holds the input second compressed audio stream S02.

The work memory 105 is shared by the first decoding process section 101 and the second decoding process section 102. The first decoding process section 101, when performing a decoding process, reads a compressed audio stream from the first input buffer 103. The second decoding process section 102, when performing a decoding process, reads a compressed audio stream from the second input buffer 104. The work memory 105 may have only a size which enables the first decoding process section 101 or the second decoding process section 102 to perform a single decoding process.

The first save buffer 106 temporarily saves the first compressed audio stream S01 stored in the work memory 105. Saving is performed when the first decoding process section 101 stops a decoding process.

The second save buffer 107 temporarily saves the second compressed audio stream S02 stored in the work memory 105. Saving is performed when the second decoding process section 102 stops a decoding process.

The first output buffer 108 holds audio data (PCM (Pulse Code Modulation) data) which is obtained by the first decoding process section 101 performing a decoding process. The second output buffer 109 holds audio data (PCM data) which is obtained by the second decoding process section 102 performing a decoding process.

The first output process section 110 converts PCM data stored in the first output buffer 108 into an audio signal in accordance with a control (described below) of the control section 112, and outputs the audio signal. The second output process section 111 converts PCM data stored in the second output buffer 109 into an audio signal in accordance with a control (described below) of the control section 112, and outputs the audio signal. Here, the output of the first output process section 110 is referred to as a first audio signal S05 and the output of the second output process section 111 is referred to as a second audio signal S06.

The control section 112 controls operations (decoding processes and output processes) of the first decoding process section 101, the second decoding process section 102, the first output process section 110, and the second output process section 111. The control section 112 receives a first output control signal S03 and a second output control signal S04. The first output control signal S03 and the second output control signal S04 are control signals for controlling the control section 112, which are used to control, for example, start of reproduction, skipping of an audio stream, a stop of outputting of an audio signal, canceling of a stop, and the like. In accordance with these signals, the control section 112 controls a decoding process (i.e., reproduction), skipping, and the like of either or both the first compressed audio stream S01 and the second compressed audio stream S02.

When both the first compressed audio stream S01 and the second compressed audio stream S02 are decoded, the control section 112 switches the start and stop of a decoding process between the first decoding process section 101 and the second decoding process section 102, where a time T1 is allocated to a decoding process with respect to the first compressed audio stream S01 and a time T2 is allocated to a decoding process with respect to the second compressed audio stream S02.

When a decoding process of the first decoding process section 101 is stopped, the control section 112 temporarily saves data stored in the work memory 105 into the first save buffer 106. When the decoding process of the first decoding process section 101 is resumed next time, the control section 112 reads the saved first compressed audio stream S01 from the first save buffer 106 into the work memory 105. When a decoding process of the second decoding process section 102 is stopped, the control section 112 temporarily saves data stored in the work memory 105 into the second save buffer 107. When the decoding process of the second decoding process section 102 is resumed next time, the control section 112 reads the saved second compressed audio stream S02 from the second save buffer 107 into the work memory 105.

It is here assumed that the control section 112 can perform saving of data stored in the work memory 105 within a process switching time Ts. Thus, in an audio decoding apparatus 120, the timing of using the work memory 105 comes to the first decoding process section 101 and the second decoding process section 102 in cycles of (T1+T2+Ts). As used herein, a total time of T1, T2, and Ts (T1+T2+Ts) is referred to as a switching cycle.

The first decoding process section 101 is assumed to output PCM data of the switching cycle (T1+T2+Ts) or more within the decoding process allocation time T1, and the second decoding process section 102 is assumed to output PCM data of the switching cycle (T1+T2+Ts) or more within the decoding process allocation time T2. In this case, the first output buffer 108 and the second output buffer 109 each need to have a capacity which can store PCM data of the switching cycle (T1+T2+Ts) or more.

Note that, as a product which is an embodiment of the audio decoding system 100, for example, the first decoding process section 101, the second decoding process section 102, the work memory 105, the first output process section 110, the second output process section 111, and the control section 112 may be provided on a single chip (referred to as the audio decoding apparatus 120), and the first input buffer 103, the second input buffer 104, the first save buffer 106, the second save buffer 107, the first output buffer 108, and the second output buffer 109 may be provided on another chip separated from the audio decoding apparatus 120 (a DRAM (Dynamic Random Access Memory) provided outside the audio decoding apparatus 120).

(Operation of Audio Decoding System 100)

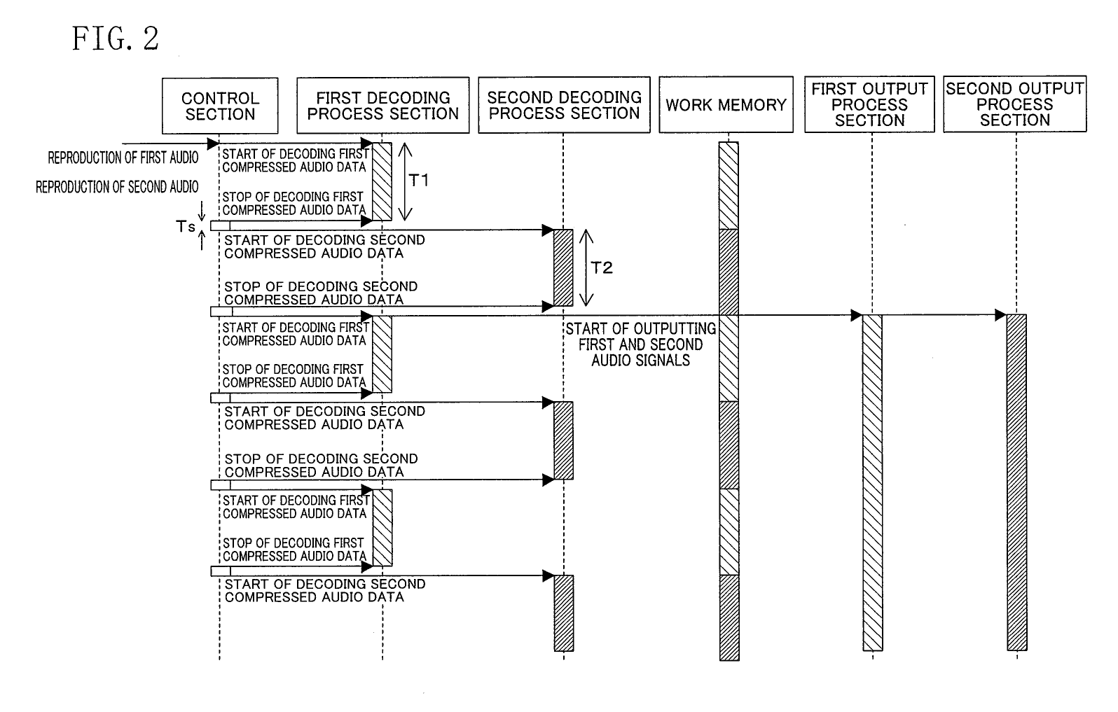

FIG. 2 is a diagram showing a process sequence of each part of the audio decoding system 100. FIG. 2 shows an example in which both the first compressed audio stream S01 and the second compressed audio stream S02 are decoded.

Initially, the control section 112, when receiving the first output control signal S03 indicating the start of reproduction of the first compressed audio stream S01 and the second output control signal S04 indicating the start of reproduction of the second compressed audio stream S02, transfers data required for a decoding process with respect to one frame of the first compressed audio stream S01 from the first input buffer 103 to the work memory 105. Further, the control section 112 causes the first decoding process section 101 to start a decoding process. Thereby, the first decoding process section 101 stores PCM data resulting from the decoding process into the first output buffer 108.

After the decoding process allocation time T1 has passed since the start of the decoding process of the first decoding process section 101, the control section 112 causes the first decoding process section 101 to stop the decoding process, and temporarily saves data stored in the work memory 105 into the first save buffer 106. Thereafter, the control section 112 transfers data required for a decoding process with respect to one frame of the second compressed audio stream S02 from the second input buffer 104 to the work memory 105. Further, the control section 112 causes the second decoding process section 102 to start a decoding process. Thereby, the second decoding process section 102 stores PCM data resulting from the decoding process into the second output buffer 109.

After the decoding process allocation time T2 has passed since the start of the decoding process of the second decoding process section 102, the control section 112 temporarily saves data stored in the work memory 105 into the second save buffer 107, and causes the first output process section 110 and the second output process section 111 to start an output process.

As described above, in the audio decoding system 100, the control section 112 switches a decoding process employing the work memory 105 between the first decoding process section 101 and the second decoding process section 102. Therefore, two compressed audio streams can be simultaneously decoded by using a work memory having a size required for a single decoding process. In other words, according to this embodiment, the size of a work memory required to simultaneously decode compressed audio streams can be reduced.

(Process When Underflow of Compressed Audio Stream Occurs)

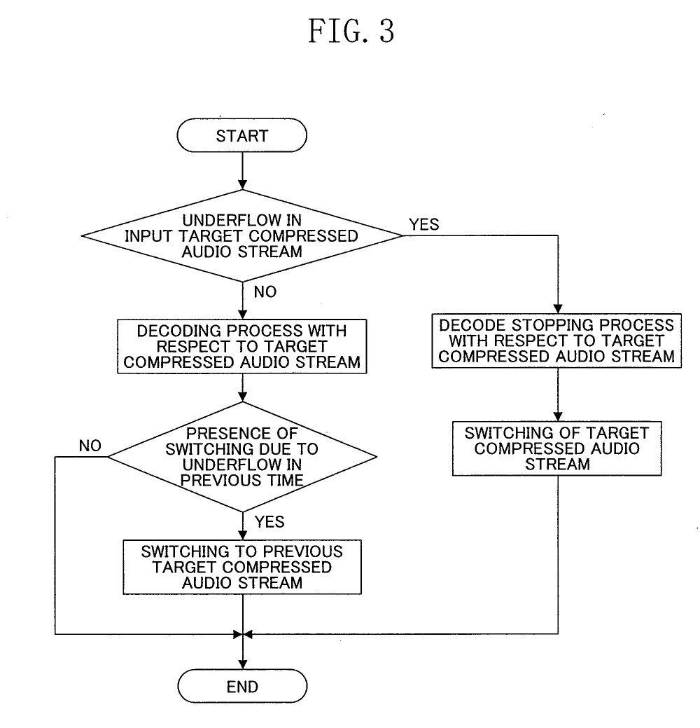

Next, a process when underflow of a compressed audio stream (e.g., the first compressed audio stream S01) is detected will be described. FIG. 3 is a flowchart showing an underflow process in the control section 112.

For example, the control section 112, when detecting underflow of the first compressed audio stream S01 to be processed, stops the first decoding process section 101 even when it is within the decoding process allocation time T1 in which the first compressed audio stream S01 would be otherwise processed, and switches a process target to the second compressed audio stream S02. After the decoding process allocation time T2 has passed, the control section 112 checks underflow of the first compressed audio stream S01 again. As a result, when there is input data, the previously stopped first compressed audio stream S01 is decoded.

By the underflow process above, in the audio decoding apparatus 120, a time during which a decoding process is stopped is reduced, thereby preventing interruption of an audio output due to underflow.

(Process When Overflow of Output Buffer Occurs)

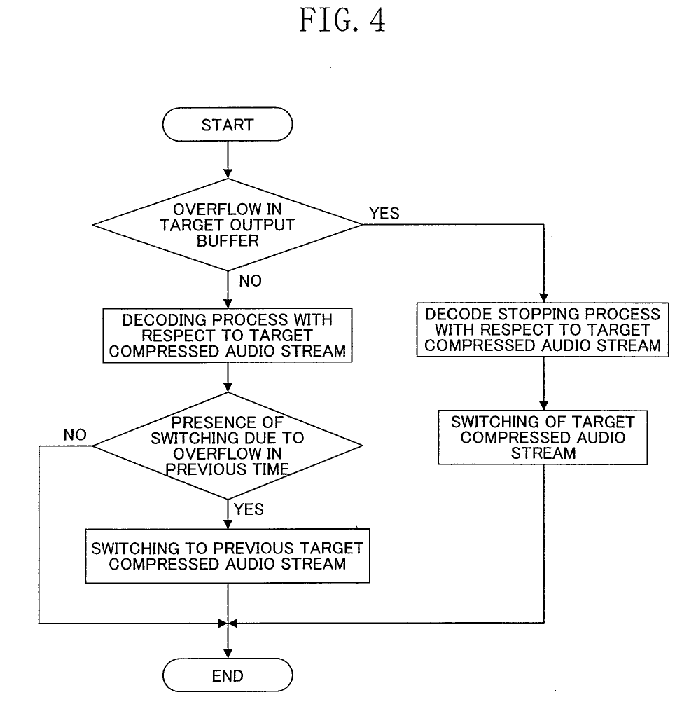

A process having a flow shown in FIG. 4 is performed when overflow of an output buffer (e.g., the first output buffer 108) is detected. FIG. 4 is a flowchart for describing an overflow process in the control section 112.

For example, the control section 112, when detecting overflow of the first output buffer 108, stops a decoding process with respect to the first compressed audio stream S01 even when it is within the decoding process allocation time T1 in which the first compressed audio stream S01 would be otherwise processed, and switches a process target to the second compressed audio stream S02. After the decoding process allocation time T2 has passed, the control section 112 checks a state of the first output buffer 108 again, and subjects the previously stopped first compressed audio stream S01 to a decoding process.

By the overflow process above, in the audio decoding apparatus 120, a time during which a decoding process is stopped is reduced, thereby preventing interruption of an audio output due to overflow.

(Skipping Process of Outputting of Audio Signal)

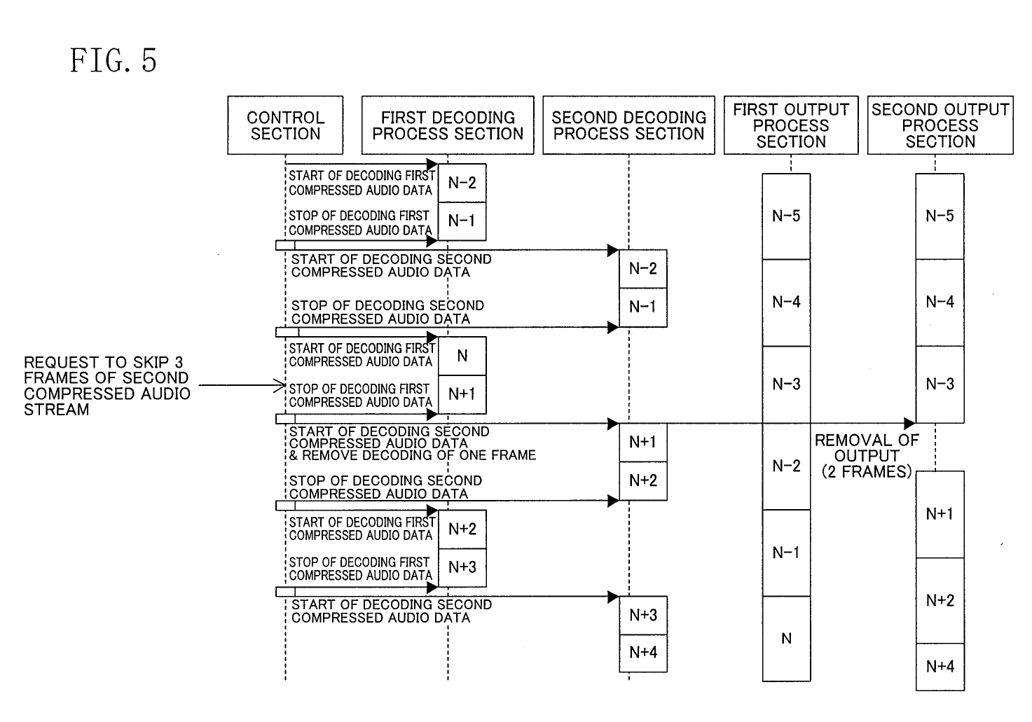

Next, an exemplary process of skipping outputting of an audio signal (e.g., the second audio signal S06) will be described. FIG. 5 is a diagram showing a process sequence when a skipping process is performed with respect to outputting of an audio signal in the audio decoding apparatus 120.

Note that it is assumed in this embodiment that the skipping process is requested by the second output control signal S04. It is also hereinafter assumed that the second output control signal S04 indicates a request to skip three frames, and two frames of PCM data (the (N−1)^{th} frame and the (N−2)^{th} frame) are stored in the second output buffer 109.

If three frames are attempted to be skipped when two frames of PCM data are stored in the second output buffer 109, underflow will occur in the second output buffer 109. Therefore, the control section 112 requests the second output process section 111 to remove the two frames of PCM data.

The control section 112 further requests the second decoding process section 102 to remove decoding of one frame so as to skip the remaining one frame. Thereby, the second decoding process section 102 skips a decoding process with respect to the N^{th} frame and starts the next decoding process from the (N+1)^{th} frame.

If the removal process is performed only with respect to a decoding process, the removal is reflected only after outputting the sound of the (N−1)^{th} frame. However, in the audio decoding apparatus 120, the removal process is performed both in the output control section and the decoding process section, the removal process can be reflected after outputting the sound of the (N−3)^{th} frame. Thus, according to the audio decoding apparatus 120, responsiveness is improved.

(Process of Stopping Audio Signal Output and Process of Canceling Stop)

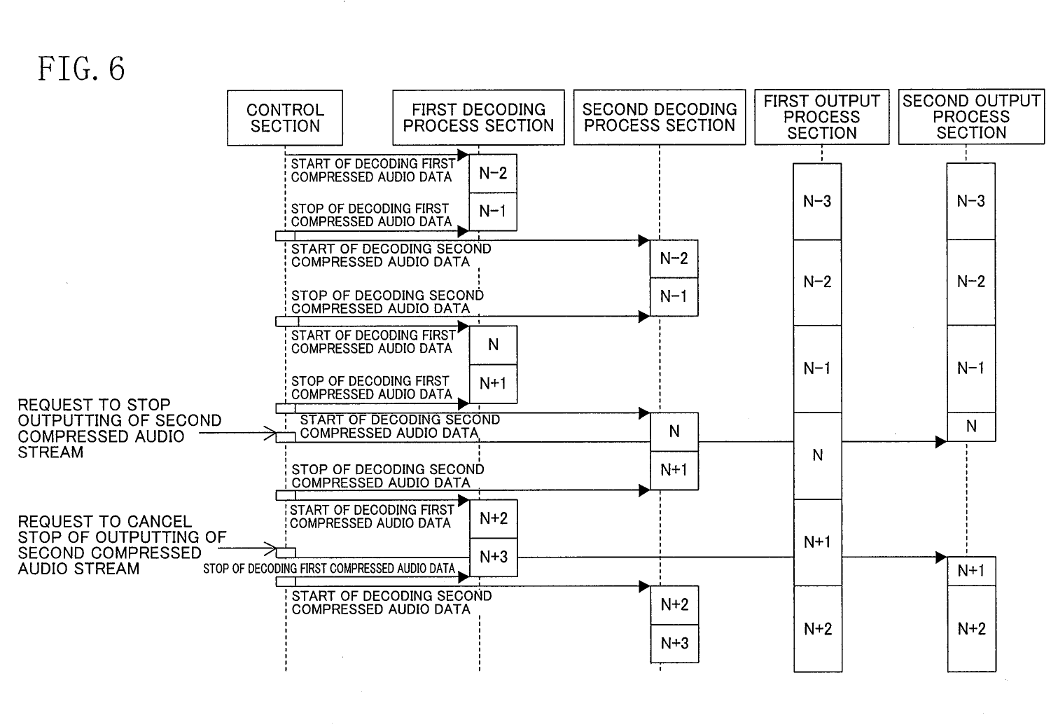

Next, an exemplary process of stopping outputting of an audio signal (e.g., the second output control signal S04) and an exemplary process of canceling a stop will be described. FIG. 6 is a diagram showing a process sequence of stopping outputting the audio decoding apparatus 120 and canceling a stop.

For example, when the second output control signal S04 indicating a request to stop outputting of the second audio signal S06, the control section 112 causes the second output process section 111 to stop an output process. In this case, the control section 112 does not cause the second decoding process section 102 to stop a decoding process until overflow occurs in the second output buffer 109 within the decoding process allocation time T2. This is because, if the second decoding process section 102 and the second output process section 111 are simultaneously stopped, then when the timing of canceling a stop falls within a time during which the second decoding process section 102 is stopped, underflow may occurs in the second output buffer 109, so that a delay may occur in outputting of sound from the second output process section 111. Thus, by this control, the responsiveness of canceling a stop of outputting is improved in the audio decoding apparatus 120.

### Variation of Embodiment 1

It has been described above that compressed audio streams to be decoded are switched, depending on the allocated time. Alternatively, for example, compressed audio streams to be decoded may be switched, depending on the remaining amounts of data of the first output buffer 108 and the second output buffer 109.

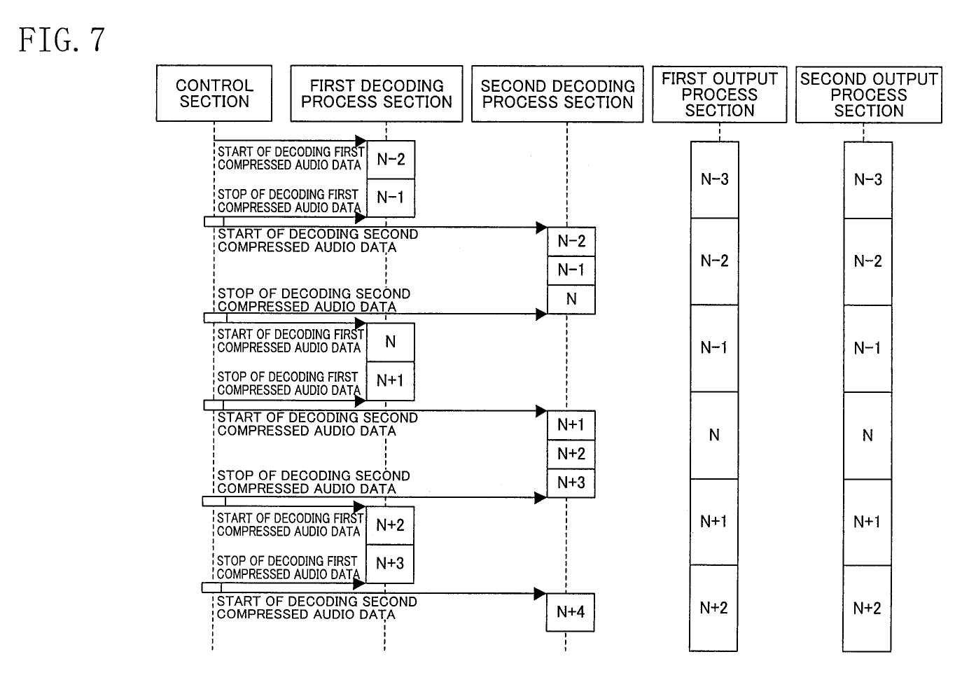

FIG. 7 is a diagram for describing a decoding process sequence of switching of two compressed audio streams, depending on the remaining amounts of data of the first output buffer 108 and the second output buffer 109 in the control section 112.

As shown in FIG. 7, while the N^{th} frame is decoded in the second decoding process section 102, audio of the (N−1)^{th} frame is output in the first output process section 110. Thereby, the remaining amount of data in the first output buffer 108 becomes one frame or less. Therefore, the control section 112 causes the first output process section 110 to stop a decoding process so as to prevent underflow of the first output buffer 108, and causes the first decoding process section 101 to resume a decoding process.

Thus, by the control section 112 controlling and switching the two decoding process sections, depending on the remaining amounts of data in the two output buffers, it is no longer necessary to previously determine the decoding process allocation times T1 and T2. Therefore, for example, even when a change occurs in the decoding process time, appropriate times can be allocated for the two decoding processes, thereby making it possible to prevent interruption in audio.

### Embodiment 2

In Embodiment 2, an exemplary apparatus which decodes and reproduces three compressed audio streams (a first compressed audio stream S01, a second compressed audio stream S02, and a third compressed audio stream S07) will be described.

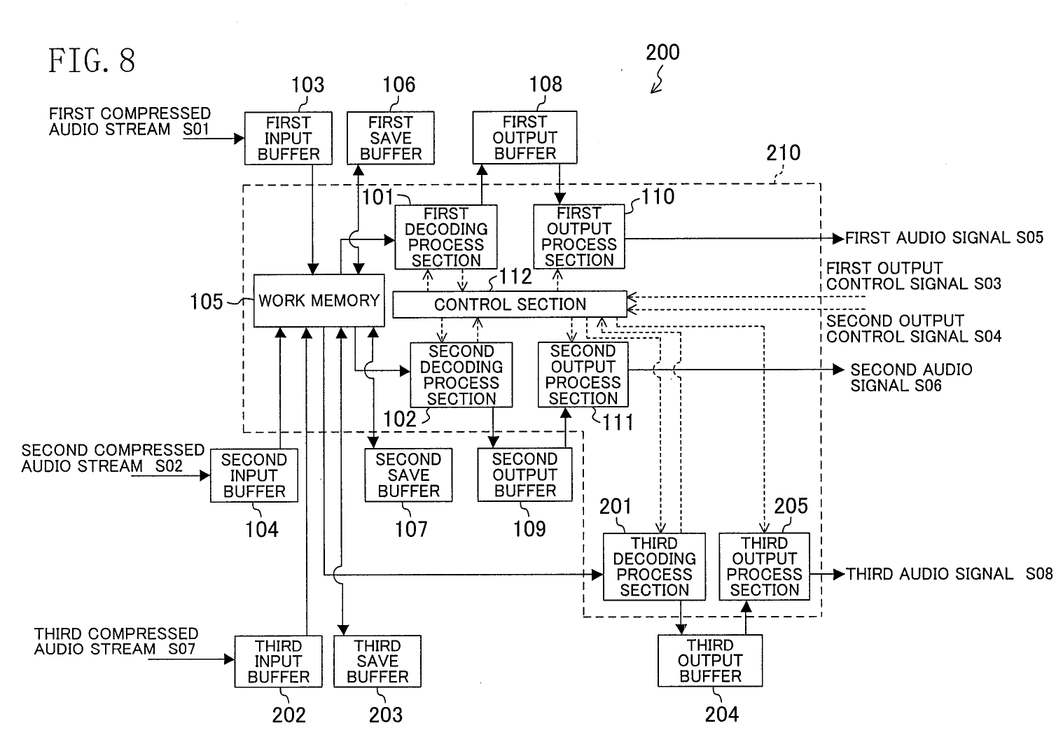

FIG. 8 is a functional block diagram showing a configuration of an audio decoding system 200 according to Embodiment 2 of the present invention. As shown in FIG. 8, the audio decoding system 200 is obtained by adding, to the audio decoding system 100, a third decoding process section 201, a third input buffer 202, a third save buffer 203, a third output buffer 204, and a third output process section 205.

The third decoding process section 201 decodes the third compressed audio stream S07 in accordance with a control (described below) of the control section 112.

The third input buffer 202 holds the input third compressed audio stream S07.

In this embodiment, the work memory 105 is used by the third decoding process section 201 as well as the first decoding process section 101 and the second decoding process section 102. When the third decoding process section 201 performs a decoding process, a compressed audio stream is read from the third input buffer 202 into the work memory 105. Also in this embodiment, the work memory 105 has a size which allows two decoding processes to be simultaneously performed.

The third save buffer 203 temporarily saves the third compressed audio stream S07 stored in the work memory 105.

The third output buffer 204 holds PCM data which is obtained by the third decoding process section 201 performing a decoding process.

The third output process section 205 converts PCM data stored in the third output buffer 204 into an audio signal and outputs the audio signal in accordance with a control (described below) of the control section 112.

When the three compressed audio streams (i.e., the first compressed audio stream S01, the second compressed audio stream S02, and the third compressed audio stream S07) are decoded, the control section 112 switches the start and stop of a decoding process between the first decoding process section 101, the second decoding process section 102, and the third decoding process section 201, where a process allocation time for a decoding process with respect to the first compressed audio stream S01 is represented by T1, a process allocation time for a decoding process with respect to the second compressed audio stream S02 is represented by T2, and a process allocation time for a decoding process with respect to the third compressed audio stream S07 is represented by T3.

After causing one of the decoding process sections to stop a decoding process, the control section 112 saves data store in the work memory 105 which was referenced by the stopped decoding process section into a save buffer while a decoding process section which uses the work memory 105, following the stopped decoding process section, performs a decoding process. After finishing saving the data, the control section 112 reads, into the work memory 105, data which will be referenced by a decoding process section which will perform a decoding process, following the decoding process section which is currently performing a decoding process.

For example, if the work memory 105 is used by the first decoding process section 101 and the second decoding process section 102 successively in this order, the control section 112 causes the first decoding process section 101 to stop a decoding process before temporarily saving, into the first save buffer 106, data stored in the work memory 105 which was referenced by the first decoding process section 101 while the second decoding process section 102 is performing a decoding process. The data temporarily stored in the first save buffer 106 is read into the work memory 105 before the decoding process is resumed next time by the first decoding process section 101. Note that it is here assumed that the control section 112 can save data into the work memory 105 within the process switching time Ts.

It is also assumed that the first decoding process section 101, the second decoding process section 102, and the third decoding process section 201 output PCM data having a total time of T1, T2, and T3 (T1+T2+T3) or more within the respective decoding process allocation times.

The first output buffer 108, the second output buffer 109, and the third output buffer 204 each have a capacity which can store PCM data having the total time (T1+T2+T3) or more.

Note that, also in this embodiment, as a product which is an embodiment of the audio decoding system 200, for example, the first decoding process section 101, the second decoding process section 102, the third decoding process section 201, the work memory 105, the first output process section 110, the second output process section 111, the third output process section 205, and the control section 112 may be provided on a single chip (referred to as an audio decoding apparatus 210), and the first input buffer 103, the second input buffer 104, the third input buffer 202, the first save buffer 106, the second save buffer 107, the third save buffer 203, the first output buffer 108, the second output buffer 109, and the third output buffer 204 may be provided on another chip separated from the audio decoding apparatus 210 (e.g., a DRAM provided outside the audio decoding apparatus 210).

(Operation of Audio Decoding System 200)

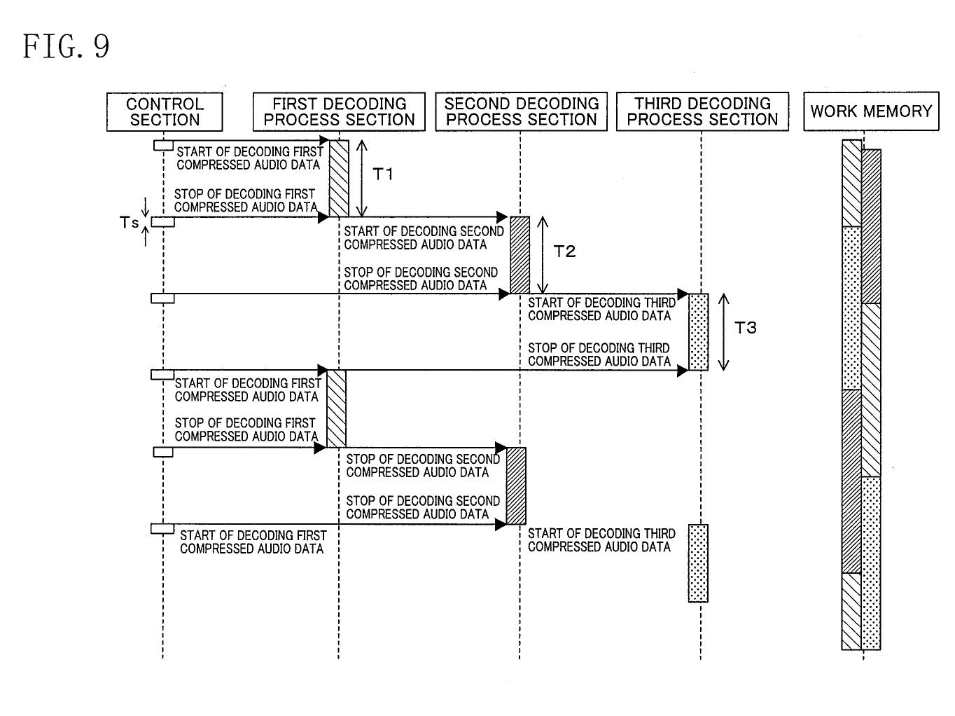

FIG. 9 is a diagram showing a process sequence of each part of the audio decoding system 200. FIG. 9 shows an example that the first compressed audio stream S01, the second compressed audio stream S02, and the third compressed audio stream S07 are decoded.

Initially, the control section 112 transfers one frame of data of the first compressed audio stream S01 required for a decoding process, from the first input buffer 103 to the work memory 105. Further, the control section 112 causes the first decoding process section 101 to start a decoding process.

Also, during the start of the decoding process, the control section 112 previously reads, from the second input buffer 104, data of the second compressed audio stream S02 which is to be decoded next time. After the decoding process allocation time T1 of the first compressed audio stream S01 has passed, the control section 112 causes the first decoding process section 101 to stop the decoding process, and at the same time, causes the second decoding process section 102 to start a decoding process. Thereafter, the control section 112 temporarily saves data stored in the work memory 105 into the first save buffer 106, and transfers one frame required for a decoding process of data of the third compressed audio stream S07 which is to be decoded next time, from the third input buffer 202 to the work memory 105.

As described above, in the audio decoding system 200, data required for a decoding process is read into the work memory 105 before the start of the decoding process. Therefore, when the control section 112 switches a decoding process between the first decoding process section 101, the second decoding process section 102, and the third decoding process section 201, a process overhead of the switching time Ts can be reduced, resulting in an increase in processing speed.

Also, in the audio decoding system 200, a work memory having a size which allows two decoding processes to be simultaneously performed can be used to simultaneously decode three compressed streams. Thus, also in this embodiment, the size of a work memory required to simultaneously decode a plurality of compressed audio streams can be reduced.

Note that the number of compressed audio streams which are simultaneously decoded in the above-described embodiments and variation are only for illustrative purposes. For example, a more number of compressed audio streams can be simultaneously decoded by providing a plurality of additional decoding process sections and output process sections to the audio decoding apparatus 120 or the audio decoding apparatus 210. In this case, input buffers, save buffers, and output buffers need to be added to match the number of compressed audio streams. Thereby, a plurality of compressed audio streams can be simultaneously decoded by using a work memory having a size which is required for a single decoding process in the apparatus of Embodiment 1 or by using a work memory having a size which is required for two decoding processes in the apparatus of Embodiment 2.

As described above, the audio decoding apparatus of the present invention has the effect of reducing the size of a work memory required to simultaneously decode a plurality of compressed audio streams, and therefore, is useful as, for example, an audio decoding apparatus for simultaneously decoding a plurality of compressed audio streams (decoding process) and outputting the result as an audio signal.

What is claimed is:

1. An audio decoding apparatus for decoding n (n: a natural number of 2 or more) input compressed audio streams to output n audio signals, comprising:
a work memory for storing compressed audio streams to be decoded, read from input buffers provided outside the audio decoding apparatus, corresponding to the respective compressed audio streams;
n decoding process sections provided, corresponding to the respective compressed audio streams, for decoding the respective corresponding compressed audio streams to output respective pieces of audio data;
n output process sections provided, corresponding to the respective decoding process sections, for converting the respective pieces of audio data output by the respective corresponding decoding process sections into respective audio signals and outputting the respective audio signals; and
a control section for controlling reading of the compressed audio streams to be decoded into the work memory, and the start and stop of a decoding process in each decoding process section,
wherein the decoding process sections decode the respective corresponding compressed audio streams read into the work memory, and output the respective pieces of audio data to respective corresponding output buffers provided outside the audio decoding apparatus, corresponding to the respective decoding process sections,
the output process sections read out the respective pieces of audio data from the respective corresponding output buffers and convert the respective pieces of audio data into the respective audio signals, and
the control section switches the start and stop of a decoding process between each decoding process section in predetermined switching cycles so that only any one of the decoding process sections uses the work memory to perform a decoding process at any single point of time,
during the switching, the control section saves, into a save buffer, a compressed audio stream stored in the work memory which has been referenced by a decoding process section to be caused to stop a decoding process, save buffers being provided outside the audio decoding apparatus, corresponding to the respective corresponding decoding process sections, and
when a stopped decoding process section is caused to resume a decoding process, the control section reads a compressed audio stream saved for the decoding process section to be caused to resume the decoding process, from the corresponding save buffer into the work memory.

2. An audio decoding apparatus for decoding n (n: a natural number of 3 or more) input compressed audio streams to output n audio signals, comprising:
a work memory for storing compressed audio streams to be decoded, read from input buffers provided outside the audio decoding apparatus, corresponding to the respective compressed audio streams;
n decoding process sections provided, corresponding to the respective compressed audio streams, for decoding the respective corresponding compressed audio streams to output respective pieces of audio data;
n output process sections provided, corresponding to the respective decoding process sections, for converting the respective pieces of audio data output by the respective corresponding decoding process sections into respective audio signals and outputting the respective audio signals; and
a control section for controlling reading of the compressed audio streams to be decoded into the work memory, and the start and stop of a decoding process in each decoding process section,
wherein the decoding process sections decode the respective corresponding compressed audio streams read into the work memory, and output the respective pieces of audio data to respective corresponding output buffers provided outside the audio decoding apparatus,
the output process sections read out the respective pieces of audio data from the respective corresponding output buffers and convert the respective pieces of audio data into the respective audio signals,
the control section switches the start and stop of a decoding process between each decoding process section in predetermined switching cycles so that only any one of the decoding process sections uses the work memory to perform a decoding process at any single point of time, and
the control section saves, into a save buffer, a compressed audio stream stored in the work memory which has been referenced by a stopped decoding process section, save buffers being provided outside the audio decoding apparatus, corresponding to the respective corresponding decoding process sections, while a decoding process section which uses the work memory next to the stopped decoding process section is performing a decoding process, and thereafter, the control section reads, into the work memory, a compressed audio stream which is referenced by a decoding process section which will use the work memory next to the decoding process section currently performing the decoding process.

3. The audio decoding apparatus of claim 1, wherein
when underflow occurs in an input buffer corresponding to a compressed audio stream which is being decoded, the control section causes a decoding process section which is performing the decoding process to stop the decoding process, and causes a decoding process section other than the stopped decoding process section to start a decoding process.

4. The audio decoding apparatus of claim 1, wherein
when overflow occurs in an output buffer corresponding to a compressed audio stream which is being decoded, the control section causes a decoding process section which is performing the decoding process to stop the decoding process, and causes a decoding process section other than the stopped decoding process section to start a decoding process.

5. The audio decoding apparatus of claim 1, wherein
the control section is configured to receive a request to skip outputting of an audio signal, and
the control section removes audio data from an output buffer corresponding to the audio signal to be skipped, and when underflow occurs in the output buffer during the removal, removes a decoding process in a decoding process section corresponding to the audio signal to skip outputting of the audio signal.

6. The audio decoding apparatus of claim 1, wherein
the control section is configured to receive a request to temporarily stop outputting of an audio signal, and
when overflow occurs in an output buffer corresponding to the audio signal for which outputting is to be temporarily stopped, the control section causes a decoding process section corresponding to the output buffer to stop a decoding process.

7. The audio decoding apparatus of claim 1, wherein
when the remaining amount of data becomes a predetermined amount or less in an output buffer other than an output buffer corresponding to a decoding process section which is performing a decoding process, the control section causes the decoding process section which is performing the decoding process to stop the decoding process even when it is within the switching cycle, and causes the decoding process section corresponding to the output buffer whose remaining amount of data becomes the predetermined amount or less, to start a decoding process.

8. An audio decoding system comprising:
the audio decoding apparatus of claim 1;
the input buffers;
the save buffers; and
the output buffers.

9. The audio decoding system of claim 8, wherein
each output buffer has a capacity which can store audio data output by the corresponding decoding process section within the switching cycle.

10. The audio decoding apparatus of claim 2, wherein
when underflow occurs in an input buffer corresponding to a compressed audio stream which is being decoded, the control section causes a decoding process section which is performing the decoding process to stop the decoding process, and causes a decoding process section other than the stopped decoding process section to start a decoding process.

11. The audio decoding apparatus of claim 2, wherein
when overflow occurs in an output buffer corresponding to a compressed audio stream which is being decoded, the control section causes a decoding process section which is performing the decoding process to stop the decoding process, and causes a decoding process section other than the stopped decoding process section to start a decoding process.

12. The audio decoding apparatus of claim 2, wherein
the control section is configured to receive a request to skip outputting of an audio signal, and
the control section removes audio data from an output buffer corresponding to the audio signal to be skipped, and when underflow occurs in the output buffer during the removal, removes a decoding process in a decoding process section corresponding to the audio signal to skip outputting of the audio signal.

13. The audio decoding apparatus of claim 2, wherein
the control section is configured to receive a request to temporarily stop outputting of an audio signal, and
when overflow occurs in an output buffer corresponding to the audio signal for which outputting is to be temporarily stopped, the control section causes a decoding process section corresponding to the output buffer to stop a decoding process.

14. The audio decoding apparatus of claim 2, wherein
when the remaining amount of data becomes a predetermined amount or less in an output buffer other than an output buffer corresponding to a decoding process section which is performing a decoding process, the control section causes the decoding process section which is performing the decoding process to stop the decoding process even when it is within the switching cycle, and causes the decoding process section corresponding to the output buffer whose remaining amount of data becomes the predetermined amount or less, to start a decoding process.

15. An audio decoding system comprising:
the audio decoding apparatus of claim 2;
the input buffers;
the save buffers; and
the output buffers.

16. The audio decoding system of claim 15, wherein
each output buffer has a capacity which can store audio data output by the corresponding decoding process section within the switching cycle.
